(19) United States
(12) Patent Application Publication
(10) Pub. No.: US 2023/0415976 A1
(43) Pub. Date: Dec. 28, 2023

(54) CAPSULE AND SYSTEM FOR PREPARING A BEVERAGE

(71) Applicant: SOCIETE DES PRODUITS NESTLE S.A., Vevey (CH)

(72) Inventors: CEDRIC RICHARD, Poliez-Pittet (CH); ARNAUD GERBAULET, Oye et Pallet (FR); VEITH BEHRMANN, Villeneuve (CH)

(21) Appl. No.: 18/254,700

(22) PCT Filed: Nov. 24, 2021
(86) PCT No.: PCT/EP2021/082806

§ 371 Date: May 26, 2023

(30) Foreign Application Priority Data
Nov. 27, 2020 (EP) 20210284.4

(51) Int. Cl. B65D 85/804; B65D 77/20; A47J 31/36

(52) U.S. Cl. CPC B65D 85/8052; B65D 77/2024; B65D 2577/205; A47J 31/3695; B65D 85/8061

(57) ABSTRACT

The invention relates to capsule for preparing a beverage comprising—a substantially rigid capsule body having a circumferential sidewall extending around an inner space of the capsule, said inner space being at least partially filled with a beverage ingredient suitable for preparing the beverage, —a rigid base wall, integral with the capsule body, the base wall covering the inner space at a first end of the sidewall, —a flange arranged circumferentially around an open side of the capsule at a second end of the sidewall of the base body opposite the base wall, —a lid covering the inner space and the open side of the capsule at a second end of the sidewall opposite the base wall and tightly closing the capsule, the lid being removably attached to the flange for use of the capsule in a beverage preparation device, and—a filter element positioned in the inner space of the capsule between the beverage ingredient and the lid; and —a carrier disk provided in the inner space of the capsule. According to the invention the carrier disk is positioned in the inner space of the capsule between the lid and the filter, said carrier disk comprising multiple preformed outlet openings suitable for draining the prepared beverage from the inner space towards the outside of the capsule when the capsule is used in the beverage preparation device; and the carrier disk comprises between 50 and 150 outlet openings and the open surface ratio of the carrier disk is higher than 4%. The invention also relates to a system comprising said capsule and to the use of said capsule and system.

### FIELD OF THE INVENTION

The invention relates to a capsule integrating a filter element for preparing a beverage, preferably a crema-free coffee, tea, milk or chocolate-based beverage.

The capsule comprises a substantially rigid capsule body having a circumferential sidewall extending around an inner space of the capsule which is at least partially filled with a beverage ingredient for preparing the beverage such as coffee, a base wall covering the inner space at a first end of the sidewall and a lid covering the inner space at a second end of the sidewall opposite the base wall. The capsule integrates in its inner space a filter and an aluminum disk comprising openings and the lid is removably attached to the capsule.

The invention also relates to a process for producing said capsule.

### BACKGROUND OF THE INVENTION

Capsules for preparing a beverage in a beverage preparation device, and presenting said features are generally known from the prior art. The beverage preparation device comprises a brewing chamber in which the capsule is positioned. Liquid from the beverage preparation device is injected in the capsule to extract the beverage from an extractable ingredient, usually roasted and ground coffee or tea, or to prepare the beverage from a soluble ingredient, usually instant coffee, instant tea or instant milk or chocolate-based product, contained within an inner space of the capsule.

In most of the capsules currently on the market, the inner space of the capsule is closed, hermetically or fluid-tightly closed from the environment prior to be use in the beverage preparation device in order to maintain or prolong a freshness of the beverage ingredient during storage.

The capsule hereto often comprises a substantially rigid capsule body having a circumferential sidewall extending around the inner space and a base wall covering the inner space at a first end of the sidewall. At a second end of the sidewall opposite the base wall the capsule body has an open filling side. A fluid and gas tight lid, for example an aluminum lid, is provided over the open filling side of the capsule body to cover the inner space. In use the capsule may be pierced, preferably at the base wall and/or the lid, to form an injection opening for injecting the liquid such as hot water, and/or to form an outlet opening which allows the prepared beverage to escape the capsule.

The known capsules are more particularly conceived for preparing an espresso type beverage using beverage preparation device delivering high pressurized hot water wherein the injection of pressurized hot water in the capsule leads to an extraction of substances from the coffee beverage ingredient and with foam forming on the beverage corresponding to an espresso beverage with a crema layer as obtained with known piston type espresso machine using high pressure brewing.

For a crema-free coffee beverage, for example a coffee beverage without foam, also referred to as filter coffee, usually specific apparatuses are used in which the beverage is prepared by unpressurized filtration of a mixture of beverage ingredient and water.

Some capsules to be used in pressurized beverage devices have been proposed for the preparation of crema free coffee.

EP 2952125 A1 discloses a capsule for preparing a beverage using an extractable product contained in an inner space of the capsule. The capsule comprises a circumferential first wall, a second wall closing the circumferential first wall at a first end, and a flexible sheet-shaped perforate and/or porous third wall closing the circumferential first wall at a second, open end opposite the second wall, thereby forming the said inner space. The third wall forms an outermost boundary of the capsule in an axial direction thereof and comprises a woven or nonwoven filtering material, such as filtering paper.

WO 2019/013623 A1 proposes a capsule comprising a rigid capsule body with a circumferential wall and a base wall that border an inner space filed with a beverage ingredient. An open filling side of the capsule at an end of the circumferential wall opposite the base wall is covered with a lid of fluid tight material. The lid is provided with a preformed outlet opening suitable for draining the prepared beverage from the inner space when the capsule is used in a beverage preparation device. The outlet opening is fluid tightly closed by a removable cover element extending over at least part of the lid.

However, these solutions are not fully satisfactory in what concerns the construction of the capsule, the ergonomic use of it by the consumer and the obtained in-cup result.

It is therefore an object of the proposed invention to provide a capsule of simple construction and corresponding system for producing a filter type coffee beverage with no crema which has all the characteristics of a filter coffee made with drip coffee machine and comply with expected sensory in-cup results expected by the consumer.

### SUMMARY OF THE INVENTION

In this respect, the invention provides a capsule for providing a crema-free coffee, tea, milk or chocolate-based beverage according to claim 1 and as described herein.

The claimed capsule is intended for preparing a beverage and comprises:
a substantially rigid capsule body having a circumferential sidewall extending around an inner space of the capsule, said inner space being at least partially filled with a beverage ingredient suitable for preparing the beverage,
a rigid base wall, integral with the capsule body, the base wall covering the inner space at a first end of the sidewall,
a flange arranged circumferentially around an open side of the capsule at a second end of the sidewall of the base body opposite the base wall,
a lid covering the inner space and the open side of the capsule at a second end of the sidewall opposite the base wall and tightly closing the capsule, the lid being removably attached to the flange for use of the capsule in a beverage preparation device, and
a filter element positioned in the inner space of the capsule between the beverage ingredient and the lid; and
a carrier disk provided in the inner space of the capsule,

The carrier disk is positioned in the inner space of the capsule between the lid and the filter, said carrier disk comprising multiple preformed outlet openings suitable for draining the prepared beverage from the inner space towards the outside of the capsule when the capsule is used in the beverage preparation device

According to the invention, the carrier disk comprises between 50 and 150 outlet openings and the open surface ratio of the carrier disk is higher than 4%.

In the example of a capsule comprising roast and ground coffee as a beverage ingredient, the specific structure of the capsule and the specific carrier disk allows when the capsule is extracted in a beverage preparation after removal of the lid to get a coffee with limited formation of foam and crema.

This freshly brewed coffee has the main characteristics of a filter-like coffee with little crema, quickly disappearing (in less than 1 or 2 mins) to leave only a crown of crema around the cup. The result-in-cup is a coffee having a low body, little acidity, and little bitterness with absence of harsh, while being aromatic, soft, smooth and sweet.

Importantly, the open surface ratio of the carrier disk is defined as being higher than 4%, and more specifically comprised between 4% and 15% and preferably between 5 and 12%. The set open surface ratio allows that no or reduced pressure building occurs in the capsule during extraction.

In the proposed solution, the carrier disk comprises between 50 and 150 openings, preferably between 70 and 120 openings, most preferably between 85 and 110 openings. Such a structure with multiple openings avoids possible channeling of the water within the coffee bed during extraction.

In addition, and also contributing to avoiding the channeling effect, the openings are homogeneously distributed on the surface of the carrier disk and spaced apart from adjacent outlet opening of a distance comprised between 0.5 mm and 3 mm.

The outlet openings of the carrier disk are circular or oblong openings. The proposed openings shape is optimized for an easy manufacturing and a lower tooling cost. However, other shape of the opening may be selected depending on the result in cup to be obtained.

In a preferred way, the outlet openings have a diameter comprised between 0.4 mm and 3 mm, most preferably between 0.5 mm and 1.3 mm. These dimensions have been calculated for a leak rate of approximately 300 ml/min.

As proposed, the carrier disk has a generally circular shape with a diameter comprised between 28.5 mm and 30.5 mm.

To allow safe and easy assembling in the capsule, the carrier disk is void of outlet openings on its external perimeter over a distance of at least 0.5 mm, preferably over a distance comprised between 0.5 to 2.5 mm and more preferably between 1 and 2 mm.

The thickness of the carrier disk is comprised between 0.05 mm and 1.5 mm, preferably between 0.1 mm and 1 mm, most preferably between 0.2 mm and 0.8 mm which gives enough stiffness to the carrier disk to resist to ejection during extraction, or after extraction due to the pressure of the swollen coffee bed.

Preferably, the carrier disk is made of Aluminum. This allows an easy recycling in the conventional aluminum stream when the capsule is done in aluminum.

In an alternative way, the carrier disk is made of plastic or of a laminated plastic element.

Considering that the capsule is to be extracted in a beverage preparation device comprising an extraction plate with tearing surfaces, the outlet openings are distributed over the carrier disk homogeneously with less than 10% of the outlet openings of the carrier disk directly facing the tearing surfaces of the extraction plate. This feature allows that the extracted coffee is not prevented from going out of the carrier disk and affected by the nearby tearing surface of the extraction plate.

Furthermore, the pattern of the outlet openings distribution over the carrier disk is also constructed in such a way that the outlet openings distribution is not depending on the angular positioning of the carrier disk with regards to the tearing surface of the extraction plate.

In the proposed capsule structure, the filter element comprises a layer of non-woven material adapted to prevent coffee drain to go through and reducing the formation of a crema layer.

In the current envisaged solution, the filter is positioned on the carrier disk. This allows an easy processing in the assembling process of the capsule. Additionally, the filter may be fixed onto the carrier disk.

The lid of the capsule comprises a free pull tab protruding from the lid. The pull tab is integral with the lid allowing to remove the full lid. This handling and opening are then easier.

In a proposed embodiment, the lid comprises at least an aluminum layer to ensure a better shelf life of the coffee in the capsule.

In addition, the lid may further comprise a plastic layer and/or a heat seal layer to ensure food grade compatibility for sealing the lid onto the flange of the capsule.

As a preference, the capsule body, the lid, and the carrier disk are each mainly made from aluminum. The use of aluminum ensures a better coffee protection and a longer shelf life. Additionally, the end of life of the capsule is easier and recycling is easier.

In an alternative way, the capsule body, the lid and the carrier disk may each be made of plastic or of a laminated or multilayer plastic element.

The proposed capsule comprises a beverage ingredient. The beverage ingredient is preferably ground coffee, preferably in an amount of at least 4 g, preferably between 4.5 g and 15 g.

Thanks to the proposed capsule construction, the carrier disk is positioned inside the capsule and kept at distance from the lid comprised, i.e., between 0.1 mm and 2 mm. This allows avoiding possible interaction between the carrier disk and the tearing surface of the extraction plate of the beverage preparation device when the coffee bed volume expands during extraction.

Indeed, the capsule should sustain an extraction of the beverage ingredient is an extraction process made at a pressure below 8 bar, more preferably below 5 bar.

The invention also provides a system as described herein.

The system of the invention aims at preparing a beverage. It comprises an exchangeable capsule and a beverage preparation device with a fluid dispensing device capable of feeding an amount of a fluid, such as water, with a pressure between 0.1 bar and 20 bar to the capsule, and with a brewing chamber, comprising a first part for holding the capsule and a second part for closing the brew chamber.

The claimed system proposes to use the exchangeable claimed capsule integrating one or more of the above disclosed features in the beverage preparation device where the second part of the brewing chamber of the beverage preparation device comprises an extraction plate for engaging with the exchangeable capsule at the second end of the sidewall when the brew chamber holding the capsule is closed, the extraction plate comprising a tearing surface facing, in use, the carrier disk at the second end of the capsule, wherein the carrier disk of the capsule in use in the closed brewing chamber is not altered by the tearing surface of the extraction plate and wherein in use, less than 10% of the outlet openings are directly facing the tearing surface of the extraction plate.

More specifically, the tearing surface of the extraction plate comprises pyramidal elements, and according to the outlet openings distribution less than 10% of the outlet openings are directly facing the pyramidal elements of the tearing surface.

Advantageously, the outlet openings distribution over the carrier disk is also constructed in such a way that the outlet openings distribution is not depending on the angular positioning of the carrier disk with regards to the tearing surface of the extraction plate.

According to the invention, the extraction of the beverage ingredient is an extraction made at a pressure below 8 bar, more preferably below 5 bar.

The invention is further directed to the use of the capsule presenting one or more of the above disclosed features alone or in a system presenting one or more of the above disclosed features.

The disclosure of the priority patent application (European patent application n° 20210284.4—filed on 27 Nov. 2020) of the current application is here incorporated by reference.

Specific embodiments of the invention are described in the following detailed description. The objects are achieved by the present invention, i.e. a capsule, a system and a capsule manufacturing method.

### BRIEF DESCRIPTION OF THE DRAWINGS

The invention is further described with reference to the following examples and drawings, which form part of the present invention. The drawings are not in any way meant to reflect a limitation of the scope of the invention, unless this is clearly and explicitly indicated. It will be appreciated that the invention as claimed is not intended to be limited in any way by these exemplary embodiments and illustrations.

It is noted that the figures are only schematic representations of embodiments of the invention that are given by way of non-limiting example.

Embodiments of the present invention will now be described, by way of examples, with reference to the accompanying figures in which:

FIG. 1a is a perspective side view of a capsule tightly closed before use in a beverage preparation device, according to the invention;

FIG. 1b is a perspective side view of a capsule in which the lid is partially removed, according to the invention;

FIG. 1c is a perspective side view of a capsule in which the lid has been removed and ready to be used in a beverage preparation device, according to the invention;

FIG. 2a is a schematic cross-sectional view of a capsule according to a first embodiment of the invention;

FIG. 2b is an enlarged view of an identified bottom portion of the capsule of FIG. 2a;

FIG. 2c is a view of the carrier disk of the capsule of FIG. 2a before being assembled in the capsule;

FIG. 3a is a schematic view of the carrier disk of the capsule of FIG. 2a once assembled in the capsule with 4 crimping points according to the first proposed embodiment;

FIG. 3b is a schematic view of the carrier disk of the capsule of FIG. 2a once assembled in the capsule with 8 crimping points according to the first proposed embodiment;

FIGS. 4a, 4b and 4c are schematic views of the carrier disk with different holes distribution patterns according to the invention;

FIG. 5 is a table presenting for different disk versions according to the invention, the dispersion's evolution over time of the creama in extracted coffee beverages;

FIG. 6a is a view of a proposed holes distribution pattern.

FIG. 6b is a transparent superposition view of the proposed holes distribution pattern of FIG. 6a with the tearing surface of the extraction plate of the beverage preparation device at three different angular position.

### DETAILED DESCRIPTION

As used in this specification, the words “comprise”, “comprising”, and similar words, are not to be interpreted in an exclusive or exhaustive sense. In other words, they are intended to mean including, but not limited to.

Any reference to prior art documents in this specification is not to be considered as an admission that such prior art is widely known or forms part of the common general knowledge in the field.

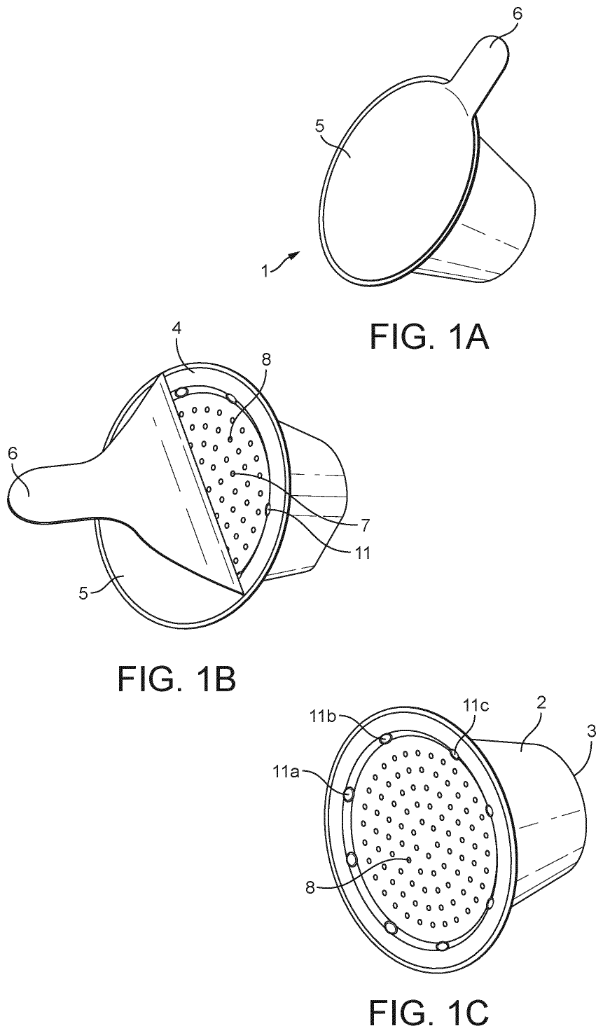

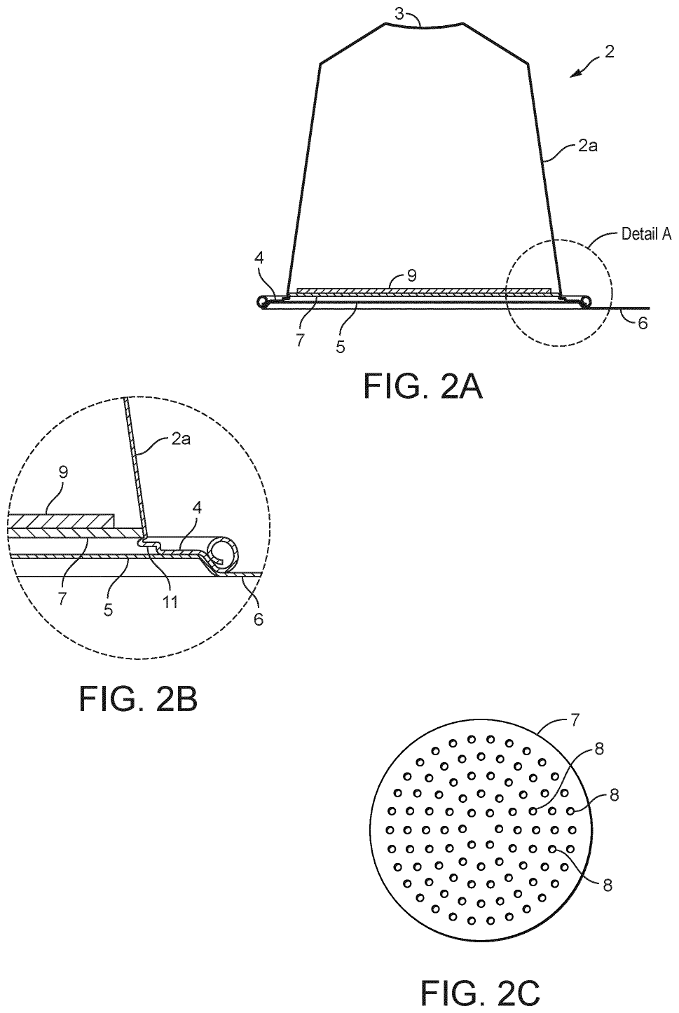

FIG. 1a shows a capsule 1 according to the invention before use in a beverage preparation device, defined as storage state. Using the reference of FIG. 2, the capsule 1 of FIG. 1a, comprises a rigid capsule body 2. The body 2 comprises a frusto-conical sidewall 2a extending circumferentially around an inner space of the body. The capsule further comprises a rigid base wall 3 integral with the capsule body 2 closing off the inner space at a first end of the side wall of the capsule body 2. A flange 4 extends radially outwardly from a second end of the side wall of the capsule body 2a. At the second end of the side wall the capsule body 2 has an open filling side.

As usual, the capsule body 2 is processed to be food grade and in most of the cases comprises a lacquer layer or a polymer film layer (not represented) applied on the inside of the capsule body.

The capsule further includes a lid 5 that is attached to the flange 4 of the capsule body thereby closing hermetically the capsule. The lid 5 may be manually removed from the capsule by pulling on a free pull tab 6. In the present case, the pull tab 6 is integral with the lid 5 and protrudes from the lid but alternative solutions are available.

The lid 5 is a flexible sheet-like foil made of aluminum with an optional heat sealing lacquer layer or a polymer layer on the sealing side.

In case the lid 5 comprises a lacquer layer on its sealing side, the thickness of the lacquer layer may be from 0.003 mm to 0.03 mm. In case the lid 5 comprises a polymer layer on the sealing side, the thickness of the polymer layer may be from 0.01 mm to 0.05 mm.

The lid 5 which is intended to be removed using the pull tab is attached to the flange 4 using an adhesive layer. The adhesive material is applied in the form of a layer of adhesive material and may be, for example, a layer of heat-seal lacquer or a polymer film layer.

As an example, the sealing layer forming the adhesive material may be a layer between 0.003 mm and 0.03 mm.

The layer of adhesive material allows removal of the lid 5 to the flange 4 of the capsule without any damage to the capsule 1.

The inner space of the capsule is filled with a beverage ingredient before the capsule is closed. In the present case, the capsule is filled with a coffee bed of roast and ground coffee before the capsule is tightly closed with the lid 5 to maintain freshness of the roast and ground coffee. The weight of the coffee is in the range of 4 g to 15 g depending on the size of the capsule. However, tea, milk or chocolate ingredients may be envisaged.

The capsule of FIG. 1b shows the capsule of FIG. 1a in which the lid 5 is partially removed by tearing the pull tab 6 and in FIG. 1c the same capsule in which the lid 5 is fully removed. As can be seen, the second end of the capsule (filling side) is no longer closed and presents on the inside of the capsule a membrane, defined as a carrier disk 7. The carrier disk 7 comprises multiple preformed outlet openings 8 for the beverage (here coffee) prepared in the beverage preparation device. The capsule also comprises mechanical deformations 11a, 11b, 11c . . . , performed at the junction between the sidewall 2a and the flange 4 that retain the carrier disk 7 inside the inner space of the capsule. Four mechanical deformations 11 are visible in FIG. 1b. These mechanical deformations 11a, 11b, 11c . . . are also visible on the capsule of FIG. 1c, indeed eight mechanical deformations can be observed. These local deformations are made using a crimping process. Their function and the way they are done will be explained in connection with FIG. 2a and followings.

The preformed outlet openings 8 of the carrier disk 7 are covered by the lid 5 of the capsule thereby closing the capsule to keep hermetic sealing of the inner space of the capsule for ensuring freshness of the beverage ingredient inside the capsule during storage.

As will be seen in the cross-sectional views of the various embodiment of the capsule of the invention (see for example FIG. 2a), the capsule further comprises in its inner space a filter element 9 positioned between the coffee bed and the carrier disk 7. The filter element 9 prevent solid particles of the beverage ingredient, for example coffee particles or tea leaves, to flow out of the capsule inside the end-consumer cup during extraction.

In the proposed invention, the capsule body 2 and the lid 5 are each mainly made from aluminum.

However, other material may be envisaged for the capsule body and the lid.

For example, the capsule body and the lid may be made of plastic polymer material, or the capsule body and the lid may be made of paper-based material.

As is understood, the capsule of the invention is extracted using a conventional high-pressure beverage preparation device compatible with conventional Nespresso® coffee capsules. The beverage preparation device comprises a fluid dispensing device capable of feeding an amount of a fluid, such as water, with a pressure between 0.1 bar and 20 bar to the capsule, and a brewing chamber, comprising a first part for holding the capsule and a second part for closing the brew chamber, the second part of the brewing chamber comprising an extraction plate presenting a tearing surface for engaging with the capsule at its second end opposite its base wall.

Summarizing a conventional extraction process of a closed capsule in the beverage preparation device: the capsule is inserted in the brewing chamber of the beverage preparation device. The fluid dispensing device feeds an amount of a fluid, such as water, to the capsule trough the base wall 3 inside the capsule to make the coffee infused and then extracted. As pressure increases inside the capsule, the lid of the capsule comes into contact with the tearing surface of the extraction plate and the lid is altered by said tearing surface leading to the formation of opening which allows the coffee to flow out of the capsule.

The formation of the outlet openings at the surface of the lid by interaction of the lid with the tearing surface for the flow out of the coffee participates to the formation of foam and cream in the preparation process.

The use of conventional capsule (closed capsule) with the above-mentioned process leads to coffee extraction at a pressure between 8 bar and 20 bar.

In the extraction process of a capsule of the invention, the lid of the capsule is removed before insertion of the capsule inside the brewing chamber of the beverage preparation device. The fluid dispensing device feeds an amount of a fluid, such as water, to the capsule through the base wall 3 inside the capsule to make the coffee infused and then extracted. The extracted coffee goes through the filter element 9 and then flows out through the outlet openings of the carrier disk 7. During extraction, the carrier disk 7 (which is at a distance from the flange of the capsule) is not intended to come into contact with the tearing surface of the extraction plate of the beverage preparation device. The carrier disk 7 is not altered by the tearing during extraction of the capsule (as it is the case of a conventional extraction of a closed capsule where the capsule membrane is teared on the tearing surface of the extraction plate, as explained in the previous section

The use of a capsule of the invention (in a conventional beverage preparation device) leads to a coffee extraction at a pressure between 0.1 bar and 8 bar, depending on the quantity of coffee inside the capsule and on the filter element structure.

Due to the fact that the lid is removed from the capsule before its use in the beverage preparation device and as the carrier disk is located inside the capsule (see FIG. 2a for example), the carrier is not intended to come into contact with the tearing surface of the extraction plate and is thus not deformed by said tearing surface.

In more details, when preparing a coffee using a capsule 1 of the invention in a beverage preparation device, the user removes the lid 5 by tearing on the pull tab 6 before inserting the capsule in a beverage preparation machine. The base wall 3 of the capsule body 2 is further pierced and opened by piercing means of a beverage preparation device for supplying water under pressure into the capsule for the preparation of a coffee beverage.

Due to the fact that the capsule is not closed (lid 5 removed and outlet openings accessible) when used in the beverage preparation device, the extraction pressure building up inside the capsule is limited (0.1 to 6 bar) and there is limited formation of foam and cream during extraction.

Hence, because the pressure built up and the sudden pressure drop are not occurring (as with the use of conventional capsule) at the interaction between the coffee/the lid/the opening element(s) with the tearing surface of the extraction plate of the beverage preparation device, the resulting coffee in cup is with little or no crema.

The capsule of the invention allows preparing crema-free coffee, tea, milk or chocolate depending on the beverage ingredient inside the capsule.

FIG. 2a shows a first embodiment of the capsule of the invention. As disclosed, the capsule comprises inside the inner space a carrier disk 7 comprising multiple preformed outlet openings 8.

As presented on FIG. 2b, which is an enlarged and cross-sectional view of the identified bottom part portion of FIG. 2a, the carrier disk 7 is positioned inside the capsule at a distance from the lid 5 comprised between 0.1 mm to 2 mm, the lid 5 being sealed on the flange 4.

This gap between the capsule lid 5 (and so the flange 4 once the lid is removed for extraction) and the carrier disk 7 provides a recess so that if the carrier disk 7 flexes during the extraction process it does not come into tearing interface with the tearing surface of the extraction plate of the beverage preparation device.

The carrier disk 7 is a substantially round piece of material as shown in FIG. 2c, and its diameter is approximately the inner diameter of capsule at the location where the carrier disk 7 is positioned/inserted/maintained depending on the assembling process.

Hence, in the proposed embodiment, the diameter of the carrier disk 7 is around 29.5 and 30.5 mm.

In the proposed embodiment, the carrier disk is made of Aluminum. Its thickness is about 0.3 mm but may vary between 0.1 mm and 1 mm.

The carrier disk is made of aluminum and in a preferred solution, as the one presented in the figures, the capsule body, the lid, and the carrier disk are each mainly made from aluminum.

In the presented solution, the carrier disk 7 is maintained inside the capsule thanks to local mechanical deformations 11 made on the capsule at the junction between the side wall 2a and the flange 4 of the capsule 1. In the detailed cross section of FIG. 2b, one mechanical deformation 11 is visible. The mechanical deformation is in the form of a crimping point 11 and is located on the side of the open side of the capsule, opposite the base wall 3.

As the capsule is made of a ductile material, preferably aluminum, the mechanical deformation by crimping allows reducing locally the diameter and thereby holding the carrier disk 7 (and filter) inside the capsule. The carrier disk is then retained inside the capsule 1.

Here, during the manufacturing process, the step of mechanically deforming the capsule at the junction of the flange 4 and sidewall 2a leading to the crimping points 11 is made on the capsule before closing the capsule with the lid 5.

The crimping points 11 (also visible on FIG. 1c), which are between 2 and 10 crimping points are angularly distributed on the perimeter of the open side of the capsule at the junction of the flange and sidewall of the capsule.

In view of the tooling that is used to make the crimping points, the crimping points 11 will preferably be equally distributed on the perimeter of the open side of the capsule.

Additionally, the crimping points 11 may have rounded crimping imprints according to the used crimping tool.

In an alternative way, the carrier disk 7 may be made of plastic or of a laminated membrane comprising for example, in polyolefins such as polypropylene, polyethylene or any other semi crystalline polymer. The carrier disk 7 may also be made of paper-based material, like a coated paper, a laminated paper or molded paper.

As can be seen on the FIG. 2c, the preformed outlet openings 9 are circular openings homogeneously distributed on the surface of the carrier disk. This homogeneous distribution of the outlet openings with ensure a homogeneous flux of the coffee flowing out of the capsule 1. This also helps to avoid creation of channel with the beverage (coffee bed) inside the capsule.

The openings have a diameter set around 0.75 mm to 1 mm, but the diameter may vary between 0.4 mm and 3 mm, most preferably between 0.5 mm and 1.3 mm.

The number of preformed outlet openings may vary depending on the size of the capsule (and on the size of the carrier disk) and on how fast the delivery of coffee is wished. In the disclosed embodiment, the carrier disk 7 comprises between 50 and 150 openings, preferably around 90 and in the presented embodiment around 100 outlet openings.

In an alternative embodiment, the preformed outlet openings may be of oblong shape.

As presented, the capsule further comprises a filter element 9 that during a possible assembling process is positioned on the ingredient bed (coffee bed for example) after the filling of the capsule, and the carrier disk 7 is positioned between the filter element and the lid 5. In an alternative assembling process, the filter is assembled onto the carrier disk and both elements are inserted into the capsule over the ingredient bed.

When the capsule is turned up-side down and as presented in the enlarged view of FIG. 2b, the filter element 9 lies on the carrier disk 7. The filter element is then supported by the carrier disk 7 inside the capsule. The filter is maintained flat inside the capsule and is not contacted by the tearing surface of the extraction plate of the beverage preparation device during extraction.

The use of a two-piece design may enable the use of none-sealable filter materials which could be an advantage for sustainability.

As proposed in this embodiment, the filter element 9 is circular with a smaller diameter than the diameter of the carrier disk 7, i.e. between 28 mm and 30.5 mm, and in general with 0.1 mmn less than the disk carrier.

However, in an alternative embodiment, the diameter of the filter element 9 could be similar to the one of the carrier disk 7.

The filter element 9 is made of non-woven material adapted to prevent/refrain coffee drains to go through too slowly or too quickly during extraction of the beverage with the aim to avoid creation of a crema layer and with the aim to avoid coffee drain going directly through the disk carrier to the cup.

The filter element 9 of the proposed embodiment comprises a thickness between 20 to 300 microns, an air permeability in the range of 100 to 5000 l/m2/s according to ISO 9237, and a weight in the range of 5 to 600 g/m2. It may for example be a paper-based filter element.

The filter elements may comprise a layer of non-woven material connected by any known means to another filtering layer.

In the proposed embodiment of FIGS. 2a to 2c, the filter element 9 and carrier disk 7 are independent elements positioned on one another. However, they may be assembled together, for example by gluing or any other means. This will then change the assembling process in the capsule as the insertion of the filter and carrier disk will be made in one step.

The proposed circular carrier disk 7 may have a tapered shape on its perimeter so as to fit (force fit) into capsules having truncated cone shape. However, other alternative shape and arrangement of the carrier disk inside the capsule may be envisaged.

It is important that the carrier disk 7 and filter element 9 remains in place inside the capsule when the lid 5 is removed and the capsule 1 extracted in the beverage preparation machine. Several assembling process may be considered and will be later on disclosed in connection with the proposed embodiments of the capsule according to the invention.

In a variant embodiment that is not represented, the carrier disk is made of plastic or of a laminated plastic element. In this situation, the assembling process of the carrier disk in the capsule would remain similar.

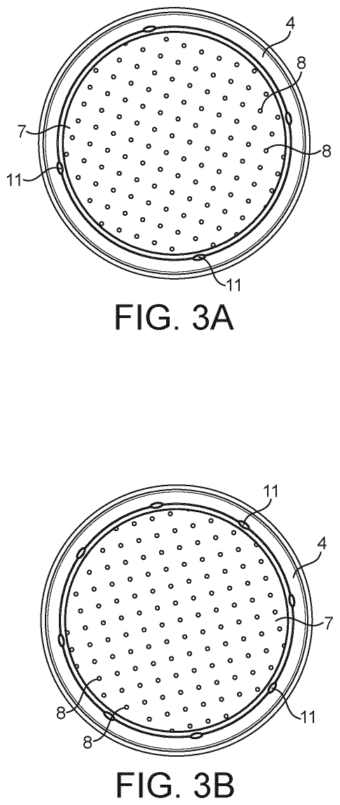

FIGS. 3a and 3b are representing the capsule of FIG. 2a (view from the open side of the capsule) with a carrier disk 7 inserted into the capsule of FIG. 2a once assembled in the capsule with, respectively, 4 and 8 crimping points before closing the open side of the capsule by attaching a lid. As can be seen, the holes distribution pattern of the carrier disk 7 is the same but viewed at two different angular position.

The number of crimping points (mechanical deformation) may vary between 2 and 10 to allow sufficient and efficient retention of the carrier disk 7 (and filter element 9 supported by the carrier disk) inside the capsule 1.

The crimping points 11 are angularly distributed around the open side perimeter of the capsule at the junction between the sidewall 2a and the flange 4 of the capsule. Preferably as here presented the crimping points are equally distributed along the perimeter of the open side of the capsule.

The currently used tooling during the step of mechanically deforming the capsule has a round end shape allowing to have crimping points with substantially rounded crimping imprints.

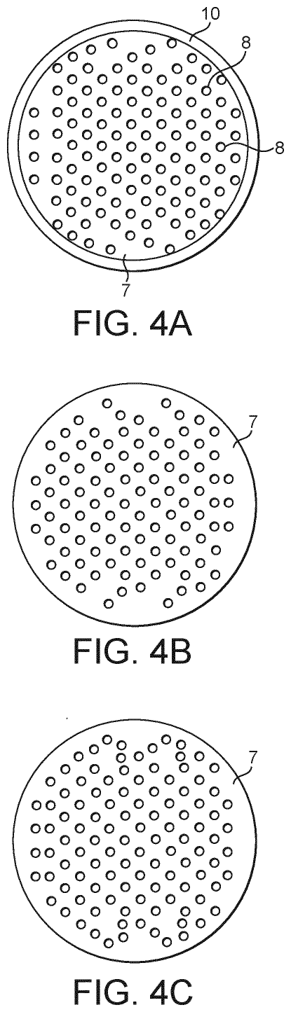

FIGS. 4a, 4b and 4c are presenting different satisfactory versions of the carrier disk 7 to be inserted in the inner space of the capsule body 2, with different holes distribution. As already seen in the previous figures, the carrier disk 7 comprises multiple preformed outlet openings 8 suitable for draining the prepared beverage from the inner space of the capsule towards the outside of the capsule when the capsule is used in the beverage preparation device.

The proposed carrier disk 7 is an aluminum disk of circular shape with a diameter that is set at 30 mm+/−3 mm. However, the diameter of the carrier disk may be comprised between 28.5 mm and 30.5 mm depending on the size and/or the construction of the capsule.

The thickness of the carrier disk 7 that is used in the capsule of FIG. 2a is around 0.3 mm. However, the thickness of the carrier disk may vary. It can be comprised between 0.05 mm and 1.5 mm, preferably between 0.1 mm and 1 mm, most preferably between 0.2 mm and 0.8 mm.

The carrier disk has a void-space 10 that is void of outlet openings on its external perimeter over a distance of at least 0.5 mm in order to avoid that during assembling some outlet openings are damaged and/or are overlapped by the crimping points (visible in FIGS. 3a and 3b). The void-space 10 is particularly visible in FIG. 4a.

As shown on the figures, the outlet openings 8 are preformed calibrated circular openings. The outlet openings 8 are homogeneously distributed on the surface of the carrier disk 7 and each outlet opening is spaced apart from adjacent outlet opening(s) of a distance of 2.5 mm however, this distance may be comprised between 0.5 mm and 3 mm. The pattern of the openings distribution generally looks like a grid or a matrix with some specific outlet openings that are referenced openings (holes) for the manufacturing process.

In the proposed embodiments, the outlet openings 8 have a diameter that is set around 1 mm. However, the outlet openings have a diameter comprised between 0.4 mm and 3 mm, preferably between 0.5 mm and 1.3 mm.

In a variant embodiment which is not represented, the outlet openings are oblong holes.

The manufacturing process of the carrier disk with the specific outlet openings distribution may be done using a punching technology of metallic foils. This type of technology uses a die to punch the material through a matrix. However, other technologies known to the skilled person may be used.

The proposed carrier disks 7 of FIGS. 4a, 4b and 4c comprise between 50 and 150 outlet openings 8 with an open surface ratio of the carrier disk higher than 4%.

The open surface ratio is defined as being the ratio between the sum of the hole's surfaces over the surface of the carrier disk. The formula is the following:

$${R}_{OS} = \frac{Σ S h}{S d}$$

Ros=open surface ratio
Sh=hole surface
Sd=carrier disk surface

In the present innovation, the initial requirement is to obtain through extraction of a single-use capsule in a conventional Nespresso® machine, a filter-like coffee with as little creama as possible. If in some case some crema is generated, it is expected that this crema disappears after 2 minutes.

The below table (table 1) shows that, not only the number of outlet openings 8 (also called holes) is important but also the size of the holes and the size of the carrier disk, leading to the open surface ratio.

Tests have been performed with on a carrier disk with a diameter of approximately 30 mm.

The data presented in table 1 show the following.

Tests 1, 2 and 5 to 7 were done with a number of holes higher than 50 and with an open surface ratio higher than 4%. The results were considered satisfactory as the resulting coffee beverages did not show any remaining crema after 2 mins from the extraction.

In test 3, when the number of holes is below 50 and the open surface ratio is lower than 4%, the extracted coffee comprises crema that does not disappear after 2 mins. The final extracted coffee was similar to a coffee obtained from the high-pressure extraction of a closed capsule.

In test 4, when the number of holes is below 50, 2 for instance, and the open surface ratio higher than 4%, coffee extraction was possible but due to technical issues linked to the piercing of the filter on the tearing surface of the machine, coffee was not satisfactory with coffee grain in the cup. The extraction process was similar to the conventional high pressure closed capsule extraction with tearing of a capsule element (here the filter) on the tearing surface of the beverage machine's extraction plate.

TABLE 1

| | Number | Holes | Open | |
|---|---|---|---|---|
| | of | diameter | surface | Results 2 mins |
| Test | holes | (mm) | ratio | after extraction |
| 1 | 98 | 0.93 | 9.5% | No remaining crema |
| 2 | 112 | 0.93 | 10.9% | No remaining crema |
| 3 | 42 | 0.93 | 3.9% | Some crema is remaining |
| 4 | 2 | 5 | 5.6% | Piercing of the filter/carrier |
| | | | | disk on the pyramid plate of |
| | | | | the machine - extraction |
| | | | | similar convention high |
| | | | | pressure closed capsule |
| | | | | extraction |
| 5 | 90 | 0.8 | 5.5% | No remaining crema |
| 6 | 95 | 0.9 | 8.7% | No remaining crema |
| 7 | 69 | 0.9 | 6.3% | No remaining crema |

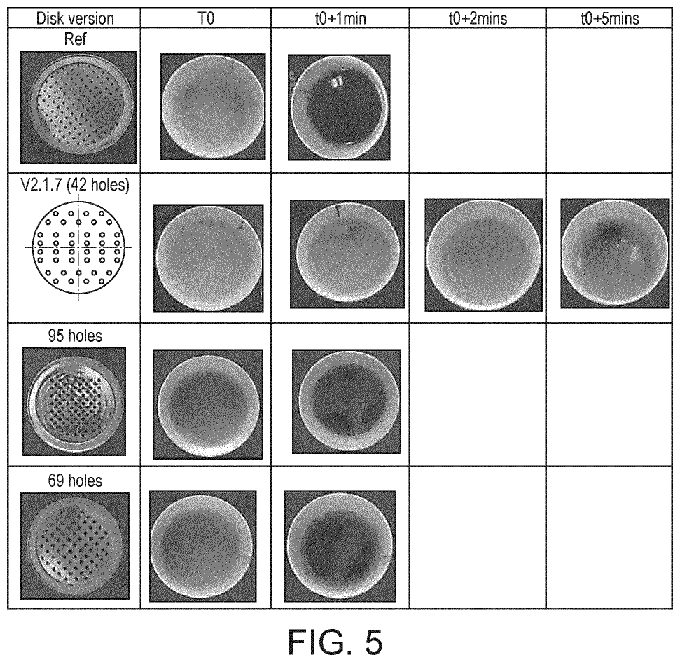

Referring to FIG. 5, a table is presented showing, for different carrier disk versions and the resulting extracted coffee (picture of the coffee cup from above), at different time, t0 corresponding to the end of the extraction, t0+1 min corresponding to 1 min after the end of extraction, t0+2 min corresponding to 2 mins after the end of extraction, and t0+5 mins corresponding to 5 mins after the end of extraction.

As can be seen, the carrier disks corresponding to the reference and to the carrier disks having more 50 holes show no crema or very little crema remaining in the cup at t0+1 min.

The carrier disk (V2.1.7) comprising 42 holes shows remaining crema in the coffee at t0+5 mins and therefore does not correspond to the expected filter-like coffee. This carrier disk can therefore not be retained for the specific purpose of producing a filter-like coffee using a single-use capsule in a conventional Nespresso® machine.

From the above results (FIG. 5 and table 1), the carrier disk preferably comprises between 70 and 120 outlet openings, and most preferably comprises between 85 and 110 outlet openings.

As for the open surface ratio of the carrier disk, the open surface ration is higher than 4% and is preferably comprised between 4% and 15%, more preferably between 5 and 12%.

Outside of these values, there are some technical limits as for the dimensions of the holes and for the number of holes on the carrier disk that would not allow an industrial forming process of such carrier disk.

For example, for openings having a diameter of 0.3 mm homogeneously distributed on a carrier disk having a diameter of approximately 30 mm
An open surface ratio of 5% lead to approximately 200 holes,
An open surface ratio of 10% lead to approximately 995 holes
An open surface ratio of 15% lead to approximately 1493 holes

which is technically not feasible at industrial level without generating quality issues.

In addition, and very importantly, the sensory requirements must be taken into account. In fact, outside of the claimed values, the extracted coffee does not correspond to the expected taste.

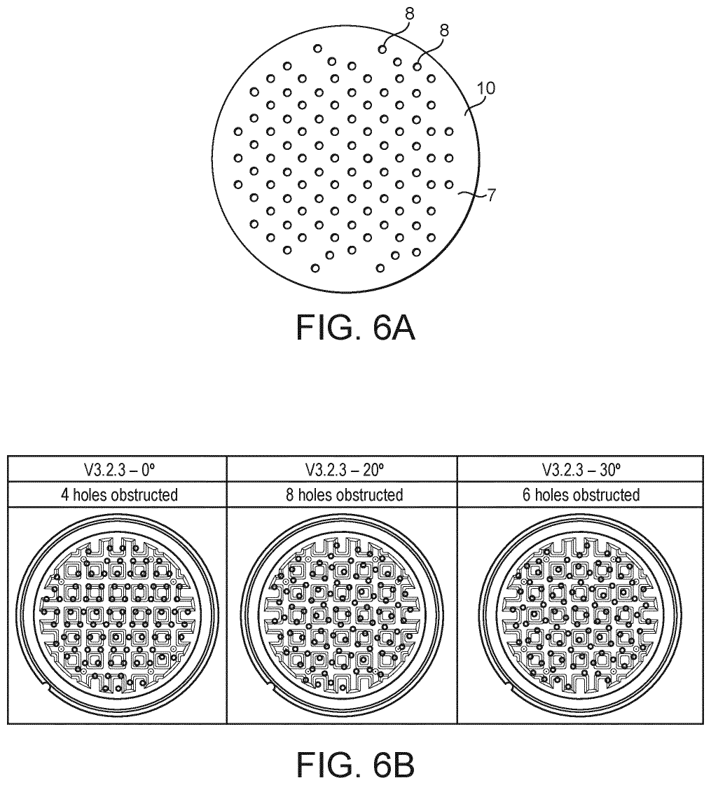

Turning to FIGS. 6a and 6b, a proposed carrier disk 7 and different orientation of this carrier disk with regards to tearing surfaces 12 of an extraction chamber of a beverage preparation device.

The presented carrier disk 7 has an approximate diameter of 30 mm and comprises 96 outlet openings distributed all over the surface of the carrier disk, with the exception of void-space 10 that is void of outlet openings 8 on its external perimeter over a distance of approximately 1 mm.

The open surface ratio of the carrier disk is around 9.3%.

In addition to the above discussed parameters, and as explained, the capsule 1 integrating said specific carrier disk 7 is intended to be extracted in a beverage preparation device or machine (not represented).

The beverage preparation device which is not represented comprises a fluid dispensing device capable of feeding an amount of a fluid, such as water, with a pressure between 0.1 bar and 20 bar to the capsule, and a brewing chamber, comprising a first part for holding the capsule and a second part for closing the brew chamber. The second part of the brewing chamber comprises an extraction plate for engaging with the exchangeable capsule at the second end of the sidewall when the brew chamber holding the capsule is closed, the extraction plate comprising a tearing surface with pyramidal elements facing, in use, the second end of the capsule.

Hence during the extraction process of the capsule of the invention, the lid of the capsule is removed before insertion of the capsule inside the brewing chamber of the beverage preparation device. The capsule and more specifically the carrier disk 7 is then facing the tearing surface (in the form of pyramid elements) of the extraction plate of the beverage preparation device.

During the extraction process, the water is injected in the capsule and mixes with the coffee ingredient disposed in the inner space of the capsule. As the lid has been removed, the extraction of the coffee ingredient is an extraction at a pressure below 8 bars, more preferably below 5 bars.

The coffee beverage then goes through the filter and aims at flowing out of the capsule through the outlet openings.

Even if, during extraction, the carrier disk does not come into a tearing interaction with the tearing surface of the extraction plate, it is important that the extracted coffee is not prevented from going out of the carrier disk and affected by the nearby tearing surface of the extraction plate.

In the proposed pattern of outlet opening's distribution, less than 10% of the outlet openings 8 of the carrier disk 7 are directly facing the tearing surfaces of the extraction plate.

The pattern is constructed in such a way that the above feature is not depending on the angular positioning of the carrier disk with regards to the tearing surface of the extraction plate.

FIG. 6b specifically shows a transparent superposition of the carrier disk and tearing surface of the extraction plate presenting the proposed holes distribution pattern of FIG. 6a at three different angular position, respectively 0°, 20° and 30°.

For each angular position of the carrier disk 7 the number of obstructed holes has been counted: 4 holes obstructed at 0°, 8 holes obstructed at 20° and 6 holes obstructed at 30°.

Thanks to the low number of holes obstructed (less than 10%) whatever the angular position of the carrier disk with regards to the tearing surface of the extraction plate, an optimized and regular flow of extracted coffee is obtained.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

### REFERENCES

1 capsule
2 capsule body/2a sidewalls
3 base wall
4 flange
5 lid
6 pull tab
7 carrier disk
8 outlet openings
9 filter
10 void-space
11 mechanical deformation/crimping

1. Capsule for preparing a beverage comprising
a substantially rigid capsule body having a circumferential sidewall extending around an inner space of the capsule, said inner space being at least partially filled with a beverage ingredient suitable for preparing the beverage,
a rigid base wall, integral with the capsule body, the base wall covering the inner space at a first end of the sidewall,
a flange arranged circumferentially around an open side of the capsule at a second end of the sidewall of the base body opposite the base wall,
a lid covering the inner space and the open side of the capsule at a second end of the sidewall opposite the base wall and tightly closing the capsule, the lid being removably attached to the flange for use of the capsule in a beverage preparation device, and
a filter element positioned in the inner space of the capsule between the beverage ingredient and the lid; and
a carrier disk provided in the inner space of the capsule,
the carrier disk is positioned in the inner space of the capsule between the lid and the filter, said carrier disk comprising multiple preformed outlet openings suitable for draining the prepared beverage from the inner space towards the outside of the capsule when the capsule is used in the beverage preparation device; and
the carrier disk comprises between 50 and 150 outlet openings and the open surface ratio of the carrier disk is higher than 4%.

2. Capsule for preparing a beverage according to claim 1,
wherein the carrier disk comprises preferably between 70 and 120 outlet openings.

3. Capsule for preparing a beverage according to claim 1, wherein the open surface ratio of the carrier disk is comprised between 4% and 15%.

4. Capsule for preparing a beverage according to claim 1 wherein the outlet openings are calibrated circular or oblong openings.

5. Capsule for preparing a beverage according to claim 1, wherein the outlet openings have a diameter comprised between 0.4 mm and 3 mm.

6. Capsule for preparing a beverage according to claim 1, wherein the outlet openings are homogeneously distributed on the surface of the carrier disk.

7. Capsule for preparing a beverage according to claim 1, wherein each outlet opening is spaced apart from adjacent outlet opening of a distance comprised between 0.5 mm and 3 mm.

8. Capsule for preparing a beverage according to claim 1 to be extracted in a beverage preparation device comprising an extraction plate with tearing surfaces, wherein less than 10% of the outlet openings of the carrier disk are directly facing the tearing surfaces of the extraction plate.

9. Capsule for preparing a beverage according to claim 1, wherein the carrier disk has a generally circular shape with a diameter comprised between 28.5 mm and 30.5 mm.

10. Capsule for preparing a beverage according to claim 9, wherein the carrier disk is void of outlet openings on its external perimeter over a distance of at least 1 mm.

11. Capsule for preparing a beverage according to claim 1, wherein the thickness of the carrier disk is comprised between mm and 1.5 mm.

12. Capsule for preparing a beverage according to claim 1, wherein the carrier disk is made of aluminum.

13. Capsule for preparing a beverage according to claim 1 wherein the capsule body, the lid, and the carrier disk are each mainly made from aluminum.

14. Capsule for preparing a beverage according to claim 1, wherein the carrier disk is made of plastic or of a laminated plastic element.

15. Capsule for preparing a beverage according to claim 1, where in the beverage ingredient comprises ground coffee in an amount of at least 4 g.

16. System for preparing a beverage comprising an exchangeable capsule comprising
a substantially rigid capsule body having a circumferential sidewall extending around an inner space of the capsule, said inner space being at least partially filled with a beverage ingredient suitable for preparing the beverage,
a rigid base wall, integral with the capsule body, the base wall covering the inner space at a first end of the sidewall,
a flange arranged circumferentially around an open side of the capsule at a second end of the sidewall of the base body opposite the base wall,
a lid covering the inner space and the open side of the capsule at a second end of the sidewall opposite the base wall and tightly closing the capsule, the lid being removably attached to the flange for use of the capsule in a beverage preparation device, and
a filter element positioned in the inner space of the capsule between the beverage ingredient and the lid; and
a carrier disk provided in the inner space of the capsule,
the carrier disk is positioned in the inner space of the capsule between the lid and the filter, said carrier disk comprising multiple preformed outlet openings suitable for draining the prepared beverage from the inner space towards the outside of the capsule when the capsule is used in the beverage preparation device; and
the carrier disk comprises between 50 and 150 outlet openings and the open surface ratio of the carrier disk is higher than 4% and a beverage preparation device with a fluid dispensing device capable of feeding an amount of a fluid, with a pressure between 0.1 bar and 20 bar to the capsule, and with a brewing chamber, comprising a first part for holding the capsule and a second part for closing the brew chamber,
wherein the exchangeable capsule comprises
a substantially rigid capsule body having a circumferential sidewall extending around an inner space of the capsule, said inner space being at least partially filled with a beverage ingredient suitable for preparing the beverage,
a rigid base wall, integral with the capsule body, the base wall covering the inner space at a first end of the sidewall, which base wall is pierced in use by at least one knife of the fluid dispensing device for the beverage preparation device for feeding the amount of fluid,
the exchangeable capsule comprising a lid covering the inner space at a second end of the circumferential wall opposite the base wall and tightly closing the capsule before use, wherein the lid is removed from the capsule when the capsule is used in the beverage preparation device,
a carrier disk positioned in the inner space of the capsule and comprising between 50 and 150 preformed outlet openings suitable for draining the prepared beverage from the inner space when the capsule is used in the beverage preparation device
wherein the second part of the brewing chamber comprises an extraction plate for engaging with the exchangeable capsule at the second end of the sidewall when the brew chamber holding the capsule is closed, the extraction plate comprising a tearing surface with pyramidal elements facing, in use, the carrier disk at the second end of the capsule, and
wherein, in use, less than 10% of the outlet openings are directly facing the pyramidal elements of the tearing surface of the extraction plate.

17. System for preparing a beverage according to claim 16 wherein the extraction of the beverage ingredient is an extraction at a pressure below 8 bars.

18. (canceled)
